(19) United States
(12) Patent Application Publication
(10) Pub. No.: US 2019/0243184 A1
(43) Pub. Date: Aug. 8, 2019

(54) LIQUID CRYSTAL PANEL AND METHOD FOR MANUFACTURING THE SAME

(71) Applicant: Shenzhen China Star Optoelectronics Technology Co., Ltd., Shenzhen (CN)

(72) Inventors: Jianjian Ying, Shenzhen, Guangdong (CN); Peng Du, Shenzhen, Guangdong (CN)

(21) Appl. No.: 15/328,925

(22) PCT Filed: Jan. 6, 2017
(86) PCT No.: PCT/CN2017/070421

§ 371 Date: Jan. 25, 2017

(30) Foreign Application Priority Data
Nov. 1, 2016 (CN) 201610934887.0

(51) Int. Cl. G02F 1/1335; G02F 1/1339

(52) U.S. Cl. CPC G02F 1/133514; G02F 1/1339; G02F 1/133512

(57) ABSTRACT

Disclosed is a liquid crystal panel. The liquid crystal panel comprises a color filter substrate. The color filter substrate comprises a first glass layer, on which a protective layer is provided. An edge of an active area of the color filter substrate is provided thereon with a black matrix layer and a sealant layer. The black matrix layer is located between the first glass layer and the protective layer. A length of the black matrix layer is smaller than that of the first glass layer. A retaining wall is provided on an upper surface of the black matrix layer, and a sealant layer is arranged at an end of the protective layer. The liquid crystal panel can effectively prevent an overlap between a PI liquid and the sealant, thereby preventing sealant peeling and improving the qualified rate of products.

### CROSS-REFERENCE TO RELATED APPLICATIONS

The present application claims the priority of Chinese patent application CN201610934887.0, entitled “Liquid Crystal Panel and Method for Manufacturing the Same”, and filed on Nov. 1, 2016, the entirety of which is incorporated herein by reference.

### FIELD OF THE DISCLOSURE

The present disclosure relates to the technical field of liquid crystal display, and in particular to a liquid crystal panel and a method for manufacturing the same.

### BACKGROUND OF THE DISCLOSURE

In manufacturing a liquid crystal panel, the active area is normally coated with a PI liquid to achieve liquid-crystal alignment. At present, the mainstream liquid crystal panels are designed with narrow bezels and curved surfaces, and the corresponding designs are usually POA (PS on Array) or COA (Color Filter on Array). In a panel designed with a narrow bezel, due to a short distance between the edge of the active area and the sealant as well as a deviation of the PI coating, the PI and the sealant can easily overlap, thus resulting in sealant peeling, causing serious product problems such as no-display and low qualified rate of products.

To address the above problem, the present disclosure proposes a liquid crystal panel and a method for manufacturing the same.

### SUMMARY OF THE DISCLOSURE

The liquid crystal panel according to the present disclosure can effectively prevent an overlap between a PI and a sealant, namely effectively preventing the sealant peeling and improving the qualified rate of products.

To achieve the above object, the present disclosure provides a liquid crystal panel, wherein the liquid crystal panel comprises a color filter substrate. The color filter substrate comprises a first glass layer, on which a protective layer is provided.

An edge of an active area of the color filter substrate is provided thereon with a black matrix layer and a sealant layer. The black matrix layer is located between the first glass layer and the protective layer. A length of the black matrix layer is smaller than that of the first glass layer. A retaining wall is provided on an upper surface of the black matrix layer.

The sealant layer is arranged at an end of the protective layer.

In the liquid crystal panel according to the present disclosure, the retaining wall is a groove provided on the upper surface of the black matrix layer and a depth of the groove is smaller than a thickness of the black matrix layer.

In the liquid crystal panel according to the present disclosure, the retaining wall is a projection provided on the upper surface of the black matrix layer.

In the liquid crystal panel according to the present disclosure, the liquid crystal panel further comprises an array substrate. The array substrate is provided thereon with a second glass layer opposite to the color filter substrate. The second glass layer is provided thereon with a metal layer which is provided on either side thereof with a gate insulating layer. The gate insulating layer is provided thereon with a first passivation layer which can protect the metal layer. The sealant layer covers the metal layer and one of the first passivation layers, and a color-resistance layer is provided on the other one of the first passivation layers.

In the liquid crystal panel according to the present disclosure, the color-resistance layer is provided thereon with a second passivation layer that can protect the color-resistance layer.

In the liquid crystal panel according to the present disclosure, the color-resistance layer is provided thereon with a photospacer which abuts against the protective layer.

In the liquid crystal panel according to the present disclosure, the color-resistance layer is a blue color-resistance layer.

In the liquid crystal panel according to the present disclosure, a height of the projection is smaller than a diatance between the color filter substrate and the array substrate.

The present disclosure further provides a method for manufacturing a liquid crystal panel. The liquid crystal panel comprises a color filter substrate. The color filter substrate comprises a first glass layer, on which a protective layer is provided.

An edge of an active area of the color filter substrate is provided thereon with a black matrix layer and a sealant layer. The black matrix layer is located between the first glass layer and the protective layer. A length of the black matrix layer is smaller than that of the first glass layer. A retaining wall is provided on an upper surface of the black matrix layer.

The sealant layer is provided at an end of the protective layer. A photo mask is provided above the color filter substrate. The photo mask comprises a first photo mask, a second photo mask, and a third photo mask. The first photo mask is arranged opposite an area of the first substrate which is provided thereon with no black matrix layer, the second photo mask is arranged opposite the black matrix layer, and the third photo mask is arranged opposite the retaining wall. Light is arranged to strike on the color filter substrate through the photo mask. A transmittance of the first photo mask is zero, and a transmittance of the second photo mask is larger or smaller than that of the third photo mask.

In the above method for manufacturing the liquid crystal panel, the transmittance of the second photo mask is 100% while the third photo mask is partially transparent, or the second photo mask is partially transparent while the transmittance of the third photo mask is 100%.

In the liquid crystal panel of the present disclosure, the retaining wall provided on the color filter substrate of can effectively prevent an overlap between the PI and the sealant, thereby preventing sealant peeling and improving the qualified rate of products. The method for manufacturing the liquid crystal panel of the present disclosure can effectively produce the retaining wall. Operation is easy and it does not have any adverse impact on the quality of the black matrix layer and the ITO layer of the color filter substrate.

### BRIEF DESCRIPTION OF THE DRAWINGS

The drawings described herein are for illustrative purposes only and are not intended to limit the scope of the present disclosure in any manner. In addition, the shapes and proportions of the components in the drawings are merely illustrative and are intended to aid in the understanding of the present disclosure and are not intended to limit the shapes and proportions of the various components of the present disclosure. Those skilled in the art, with the teachings of the present disclosure, may by way of example, select various possible shapes and proportions to implement the present disclosure.

FIG. 1 schematically shows the structure of a liquid crystal panel;

FIG. 2 schematically shows the structure of a color filter substrate of the present disclosure (1);

FIG. 3 schematically shows the structure of a color filter substrate of the present disclosure (2);

FIG. 4 schematically shows a manufacturing process of the retaining wall of the present disclosure (1); and

FIG. 5 schematically shows a manufacturing process of the retaining wall of the present disclosure (2).

### DETAILED DESCRIPTION OF THE EMBODIMENTS

Details of the present disclosure will be more apparent from the following description of the accompanying drawings and the embodiments of the present disclosure. However, the embodiments of the present disclosure described herein are for the purpose of explaining the present disclosure and are not to be construed as limiting the present disclosure in any manner. It will be apparent to those skilled in the art that those skilled in the art may contemplate any possible variations based on the present disclosure, which are to be considered as falling within the scope of the present disclosure, which will be further described below with reference to the accompanying drawings.

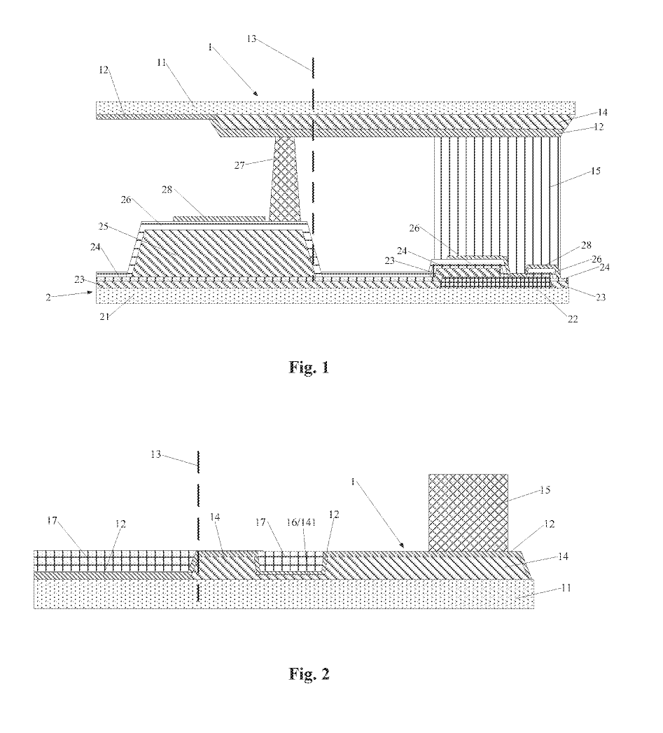

FIGS. 1 to 5 are respectively a schematic view of the structure of a liquid crystal panel, a schematic view of a structure of a color filter substrate of the present disclosure, a schematic view of another structure of the color filter substrate of the present disclosure, a schematic view of a manufacturing process of a retaining wall of the present disclosure, and a schematic view (2) of the manufacturing process of the retaining wall of the present disclosure.

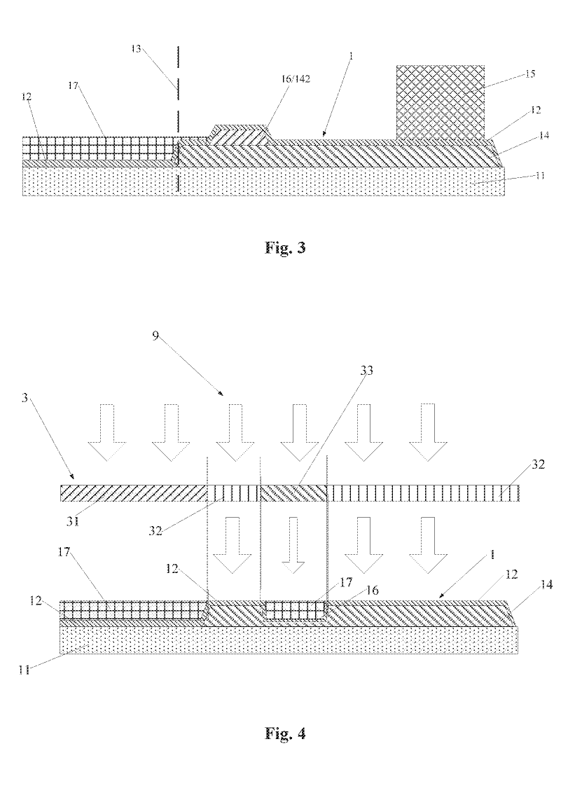

As shown in FIG. 2 and FIG. 3, a liquid crystal panel of the present disclosure comprises a color filter substrate 1. The color filter substrate 1 comprises a first glass layer 11 which is provided thereon with a protective layer 12 made from ITO. A black matrix layer 14 and a sealant layer 13 are provided on an edge of an active area of the color filter substrate 1. The black matrix layer 14 is located between the first glass layer 11 and the protective layer 12, and has a length smaller than the first glass layer 11. A retaining wall 16 is arranged on an upper surface of the black matrix layer 14, and a sealant layer 15 is provided at an end of the protective layer 12.

In the present disclosure, the retaining wall 16 has two structural forms. The first structural form is illustrated in FIG. 2, where the retaining wall 16 is a groove 141 provided on the upper surface of the black matrix layer 14 and a depth of the groove 141 is smaller than a thickness of the black matrix layer 14.

The second structural form of the retaining wall 16 of the present disclosure, as illustrated in FIG. 3, is a projection 142 provided on the upper surface of the black matrix layer 14.

Further, as illustrated in FIG. 1, the liquid crystal panel of the present disclosure further comprises an array substrate 2 which is provided thereon with a second glass layer 21 opposite to the color filter substrate 1. A metal layer 22 is provided on the second glass layer 21. Specifically, the metal layer 22 is a gate, and gate insulating layers 23 are provided on both sides of the metal layer 22. First passivation layers 24 which can protect the metal layer 22 are provided on the gate insulating layer 23. The sealant layer 15 covers the metal layer 22 and one of the first passivation layer 24, and a color-resistance layer 25 is provided on another first passivation layer 24. In one embodiment, the color-resistance layer 25 is a blue color-resistance layer.

Further, a second passivation layer 26 is provided on the color-resistance layer 25 for protecting the color-resistance layer 25. In one embodiment, an ITO layer 28 is provided on the second passivation layer 26.

Still further, a photospacer 27 (or PS retaining wall) is provided on the color-resistance layer 25 and the photospacer 27 abuts against the protective layer 12, thereby sustaining the array substrate 2 and the color-resistance layer 1.

In the present disclosure, a height of the projection 142 is smaller than a distance between the color filter substrate 1 and the array substrate 2, thereby preventing damage to the array substrate 2 by the projection 142.

The color filter substrate 1 and the array substrate 2 are coated with a PI liquid 17 before they are aligned with each other. Deviation in the PI liquid 17 coating is likely to result in an overlap between the PI liquid 17 and the sealant layer 15, thereby leading to peeling of the sealant layer 15. The retaining wall 16 of the present disclosure can effectively prevent an overlap between the PI liquid 17 and the sealant layer 15, and further improve the quality of the liquid crystal panel and the qualified rate thereof.

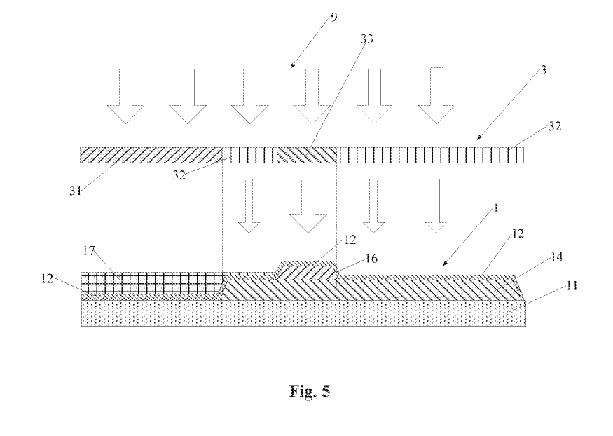

As illustrated in FIG. 4 and FIG. 5, the present disclosure further provides a method for manufacturing the liquid crystal panel of the present disclosure. Specifically, a photo mask 3 is provided above the color filter substrate 1. The photo mask 3 comprises a first photo mask 31, a second photo mask 32 and a photo mask 33, wherein the first photo mask 31 is arranged opposite an area of the first substrate 11 beyond the black matrix layer 14; the second photo mask 32 is arranged opposite the black matrix layer 14; and the third photo mask 33 is arranged opposite the retaining wall 16. Light 9 is provided to strike on the color filter substrate 1 through the photo mask 3. The transmittance of the first photo mask 31 is zero and the transmittance of the second photo mask 32 is larger or smaller than that of the third photo mask 33.

In one embodiment, the transmittance of the second photo mask 32 is 100% while the third photo mask 33 allows light to partially pass through. In one embodiment, the transmittance of the third photo mask 33 is 50%.

In another embodiment, the second photo mask 32 allows light to partially pass through while the transmittance of the third photo mask 33 is 100%. In one embodiment, the transmittance of the second photo mask 32 is 50%. The transmittance of the third photo mask 33 and the transmittance of the second photo mask 32 of course can be set as other values, as long as they are not identical to each other, and the present disclosure is not limited thereto.

The present disclosure has 2 embodiments for the photo mask 3. In embodiment 1, the photo mask 3 can be an HTM photo mask, on which different areas are formed from different materials. Different materials absorb different amounts of light, thereby realizing diversification of light transmittance of different areas of the mask and further the black matrix layer 14 with different film thicknesses after image development. Because negative color-resistance is usually applied to the color filter substrate 1, and it will not be washed off when being exposed to light, the black matrix layer herein will be retained. In FIG. 4, an area of the photo mask 3 corresponding to an area of the first glass layer 11 provided thereon with no black matrix layer 14 is designed nontransparent, i.e. Tr=0% (corresponding to the first photo mask 31 in FIG. 4), and the black matrix layer 14 in said area of the first glass layer 11 to which said area of the photo mask 3 corresponds will be washed off by a developing solution; an area of the photo mask 3 corresponding to the black matrix layer 14 is designed transparent, i.e. Tr=100% (corresponding to the second photo mask 32 in FIG. 4), and the black matrix layer 14 will remain on the color filter substrate 1; an area of the photo mask 3 corresponding to the groove 141 of the black matrix layer 14 is designed semitransparent, i.e. Tr=50% (corresponding to the third photo mask 33 in FIG. 4), and this transmittance can be adjusted on the basis of experiment results. Provided is an exemplary transmittance only. Being semitransparent means that said area is covered merely with a thin layer of color resistance, and the color-resistance can be partly washed off, thereby forming a groove 141 in FIG. 4. In addition, the shape, position and depth of the groove 141 can be adjusted by controlling the thickness of the coating of the black matrix layer 14 and by controlling the transmittance of the semitransparent area of the photo mask 3, so that an optimum effect of preventing the PI liquid 17 can be achieved. An evaporation coating s applied to the front surface of the ITO layer and a photo mask is not necessary.

Embodiment 2 of the photo mask 3 is illustrated in FIG. 5, in which the photo mask 3 is an HTM photo mask. Negative color-resistance is usually applied to the color filter substrate 1. In FIG. 5, an area of the photo mask 3 corresponding to an area of the first glass layer 11 provided thereon with no black matrix layer 14 is designed nontransparent, i.e. Tr=0% (corresponding to the first photo mask 31 in FIG. 5); an area of the photo mask 3 corresponding to the black matrix layer 14 is designed semitransparent, i.e. Tr=50% (corresponding to the second photo mask 32 in FIG. 5), and Tr=50% is just a sample transmittance which can be adjusted on the basis of experiment results; an area of the photo mask 3 corresponding to the projection 142 of the black matrix layer 14 is designed completely transparent, i.e. Tr=100% (corresponding to the third photo mask 33 in FIG. 5). As in embodiment 1 of the photo mask, the shape, position and depth of the projection 142 can be adjusted by controlling the thickness of the coating of the black matrix layer 14 and by controlling the transmittance of the semitransparent area of the photo mask 3, so that an optimum effect of preventing the PI liquid 17 can be achieved. Evaporation coating is applied to the front surface of the ITO layer and a photo mask is not necessary.

While the present disclosure has been described with reference to preferred embodiments, various modifications may be made thereto without departing from the scope of the present disclosure, and equivalents may be substituted for equivalents thereof. In particular, the technical features mentioned in the various embodiments may be combined in any manner as long as there is no structural conflict. The present disclosure is not limited to the specific embodiments disclosed herein, but includes all technical solutions falling within the scope of the claims.

1. A liquid crystal panel, comprising a color filter substrate, wherein the color filter substrate comprises a first glass layer which is provided thereon with a protective layer,
wherein an edge of an active area of the color filter substrate is provided thereon with a black matrix layer and a sealant layer,
wherein the black matrix layer is located between the first glass layer and the protective layer, and has a length smaller than the first glass layer, and is provided on an upper surface thereof with a retaining wall, and
wherein the sealant layer is arranged at an end of the protective layer.

2. The liquid crystal panel according to claim 1, wherein the retaining wall is a groove provided on the upper surface of the black matrix layer and a depth of the groove is smaller than a thickness of the black matrix layer.

3. The liquid crystal panel according to claim 1, wherein the retaining wall is a projection provided on the upper surface of the black matrix layer.

4. The liquid crystal panel according to claim 3, further comprising an array substrate, wherein the array substrate is provided thereon with a second glass layer opposite to the color filter substrate, wherein the second glass layer is provided thereon with a metal layer which is provided on either side thereof with a gate insulating layer, wherein the gate insulating layer is provided thereon with a first passivation layer which can protect the metal layer, wherein the sealant layer covers the metal layer and one of the first passivation layers, and a color-resistance layer is provided on the other one of the first passivation layers.

5. The liquid crystal panel according to claim 4, wherein the color-resistance layer is provided thereon with a second passivation layer that can protect the color-resistance layer.

6. The liquid crystal panel according to claim 4, wherein the color-resistance layer is provided thereon with a photospacer which abuts against the protective layer.

7. The liquid crystal panel according to claim 4, wherein the color-resistance layer is a blue color-resistance layer.

8. The liquid crystal panel according to claim 5, wherein the color-resistance layer is a blue color-resistance layer.

9. The liquid crystal panel according to claim 6, wherein the color-resistance layer is a blue color-resistance layer.

10. The liquid crystal panel according to claim 5, wherein a height of the projection is smaller than a distance between the color filter substrate and the array substrate.

11. A method for manufacturing a liquid crystal panel, wherein the liquid crystal panel comprises a color filter substrate, wherein the color filter substrate comprises a first glass layer which is provided thereon with a protective layer,
wherein an edge of an active area of the color filter substrate is provided thereon with a black matrix layer and a sealant layer,
wherein the black matrix layer is located between the first glass layer and the protective layer, and has a length smaller than the first glass layer, and is provided on an upper surface thereof with a retaining wall,
wherein the sealant layer is arranged at an end of the protective layer,
wherein a photo mask is provided above the color filter substrate, wherein the photo mask comprise a first photo mask, a second photo mask, and a third photo mask, wherein the first photo mask is arranged opposite an area of the first substrate which is provided thereon with no black matrix layer, the second photo mask is arranged opposite the black matrix layer, and the third photo mask is arranged opposite the retaining wall,
wherein light is arranged to strike on the color filter substrate through the photo mask, and
wherein a transmittance of the first photo mask is zero, and a transmittance of the second photo mask is larger or smaller than that of the third photo mask.

12. The method for manufacturing the liquid crystal panel according to claim 11, wherein the transmittance of the second photo mask is 100% while the third photo mask is partially transparent, or the second photo mask is partially transparent while the transmittance of the third photo mask is 100%.
